(19) United States
(12) Patent Application Publication
(10) Pub. No.: US 2021/0294064 A1
(43) Pub. Date: Sep. 23, 2021

(54) An Integrated System Combining Software and Hardware Together

(71) Applicant: Anwar Henein, Obour City (EG)

(72) Inventor: Anwar Henein, Obour City (EG)

(21) Appl. No.: 17/048,905

(22) PCT Filed: Apr. 17, 2019
(86) PCT No.: PCT/EG2019/000011

§ 371 Date: Oct. 19, 2020

(30) Foreign Application Priority Data
Apr. 18, 2018 (EG) 2018040644

(51) Int. Cl. G02B 7/02; G02B 25/00; G06Q 30/02; H04M 1/02; H04N 5/225

(52) U.S. Cl. CPC G02B 7/023; G02B 25/002; H04N 5/2254; H04M 1/0264; G06Q 30/0267

(57) ABSTRACT

The present invention relates to a new integrated system combining hardware and software together. It helps solving some existing problems and makes matters easier for the users of such new technology. This new technology enables users to dispense of some tools, like selfie stick, altogether with other tools used all the time. This new technique is not limited to specific age bracket, as it suits men, women and children. It enables user to clearly see numbers and messages at sunlight, via a novel software operable with all languages of computer and mobile (Windows, Android, Mac, IOS and others), in addition to a hardware.

### TECHNICAL FIELD

Integrated System Combining Software and Hardware

### BACKGROUND ART

### Prior Art

The prior art technique related to the field of mobile phones, with all its types and languages, and computers, with all its types and languages, has not disclosed the novel concept, with its advantages and capabilities.

### Problem with Prior Art

All current types of computers, mobile phones and tablets do not include a mirror as software and hardware. In addition, one cannot easily read words while being exposed to sunlight, neither write under direct light.

### DISCLOSURE OF THE INVENTION

### Element of Novelty

The present invention relates to using the computer, the mobile phone and the tablet as a mirror (ordinary concave-convex mirror) or a multimodal caricatural mirror. This new software is operable with all languages of computer and mobile phones, as well as other current and future languages, in addition to IOS (Android, widows and other languages).

The new technique allows the user to take selfie photos, with full appearance for a group or person, due to the presence of a chip fixed on the camera lens, which may be moved manually, mechanically or electronically. This chip is fixed circularly or in the form of a moving belt from up to down along the mobile phone. The chip makes the camera lens similar to the peephole used for house doors, i.e. it can reveal remote objects, and it allows taking selfie photos while still standing away from the camera.

The new technique also allows reading messages at sunlight or bright light, since it converts the screen into black with letters and numbers taking different colors that can be easily seen, even at day light. One can easily read or write using this new technique, and one may also change the keyboard color as desired. One may also write messages and numbers at day light or at strong light at night.

One may make use of a space at one side of the mirror, or all sides or part of them to design various, fixed or moving, advertisements, and the advertisements may also be placed at the intervals between mirrors. Such advertisements may be controlled regarding being fixed or moving with respect to the hardware. Chips may be installed in the form of a circle. Such chips are similar to lenses and have the capability of zooming in and out mechanically, electronically or manually. Such chips may also be placed horizontally to rotate around a pivot at the center of the circle. It may rotate clockwise or counter-clockwise, so as to reach finally to the lens to be placed above the camera lens.

The chips on the circle are numbered so as any of the lenses fixed on the circle may be installed on the camera kens.

One or more of these circles supporting the chips may be located on the lens.

The chips may also be placed on a bar rotating before and behind the camera (like the manner of a cassette) and moving in a reciprocal manner. An external lens may be provided in the form of a peephole, which can be installed and removed easily from the mobile phone to take a selfie photo. That is, a peephole may be mounted on the camera of the mobile phone and other devices in the selfie mode to get a full image as if taken from a remote site. This peephole can be fixed on any front or back camera, and may also be used for other devices, if required.

The present invention combines software and hardware altogether to form an integrated system. This software is operable under all electronic languages, such as Windows, Android and other languages, besides other future languages IOS.

The present invention finds usage in computers, smart phones, conventional mobile phones, tablets. Using this software, together with the hardware, the screen of the mobile phone, the computer and the tablet may be converted into a concave, convex, ordinary or minimizing mirror. Further, mirrors with different geometric shapes may be designed, and more than one mirror can be installed on one screen to allow visualizing oneself from all sides as one image at the same time. One can take a selfie photo through print screen.

A convex mirror may be used combined with a concave mirror and an ordinary mirror at the same time, which can be easily controlled in a manner that suits individual requirements. One or more software mirrors may be used in one screen, while using mirrors capable of converting normal shapes into various caricatural shapes, and one may also take a photo at any time from the screen through print screen.

As per the caricatural mirror, the user can activate the related program so as to have the option of continuous change of the mirror, i.e. to have our photos in caricatural mode which varies continuously. Further, one mirror may be located at the screen (whether convex, concave, ordinary mirror or even a peephole-like mirror which gives a remote view of an object, like peephole used for house doors). For taking a selfie photo, one may use the peephole-like mirror, then make print screen to have a unique selfie photo revealing most of the individuals. That is, one may take a selfie photo, whether caricatural, if the caricatural mirror is used, or one may take a photo by pressing a side button for printing the screen as it is to get the photo as desired. One can take a selfie photo using a software button at any place of the screen so as to print the screen and get a marvelous selfie photo, or take a photo by the camera.

The caricatural mirror may be arbitrary changed to get an unexpected selfie photo, which allows the user to take funny instant selfie photos, or predetermined photos.

A mirror (whether convex, concave, ordinary, magnifying or minimizing) can be used, with different shapes (circular, oval, triangular, rhombus). More than one mirror may be used in different positions to allow a complete view of the face from all sides. The mirror may be configured into any geometric shape, with varying colors, whether in the frame or any other part of the mirror. Certain parts of the mirror, whether the frame, the upper or lower sides or any other part, may be specified for advertisement, as desired; these advertisements may be stationary or moving, and more than one advertisement may be displayed at the same time, with different colors.

### BRIEF DESCRIPTION OF THE DRAWING

FIG. 1
1—Lens holder
2—Lens axis
3—Lenses with specific numbers referring to different strengths and focuses, such as minus 1, minus 2, minus 5 or more, whereas more than one lens is fixed on the circular or rectangular rubber band
4—A protruding body for locating the suitable lens above mobile camera
5—A body adhered to the mobile through an air discharging method or a holder for fixing the lens-bearing body on mobile back

FIG. 2
1—A lens holder
2A&2B—A nylon piece for fixing the above-mentioned shapes on the mobile
3—Mobile body and mobile camera on which the magnifying and minimizing lenses are fixed

FIG. 3
1—Lenses mounted on a fixed band that can be pulled to locate the said lenses above mobile/computer camera to have the best selfie photo
2—A joint, appropriate to the mobile thickness, for fixing the lens holder to the mobile back
3—A spring holder for tightly fixing the lens holder

Both the lens and lens holder should be of a good design to avoid degrading image quality by the influence of external environment

FIG. 4 illustrates the mobile front surrounded by a rubber band as a lens holder. The mobile camera appears as well.

FIG. 5
1—A mobile holder for the lens band
1A, 1B—lenses fixed on the lens band

FIG. 6
1—Ordinary mobile cover
2—Double-faced thin mirror
3—Joints for easy movement of the mirror (one-face normal, magnifying or minimizing mirror):
a—A durable rubber holder for lens fixation, whereas the lenses can be easily moved to locate the proper lens on mobile camera for capturing selfie photos without the use of selfie stick
2—A lens band fixed on a rubber holder

A holder, appropriate to the mobile thickness, for fixing lenses on the mobile

A holder for moving lenses from one location to another

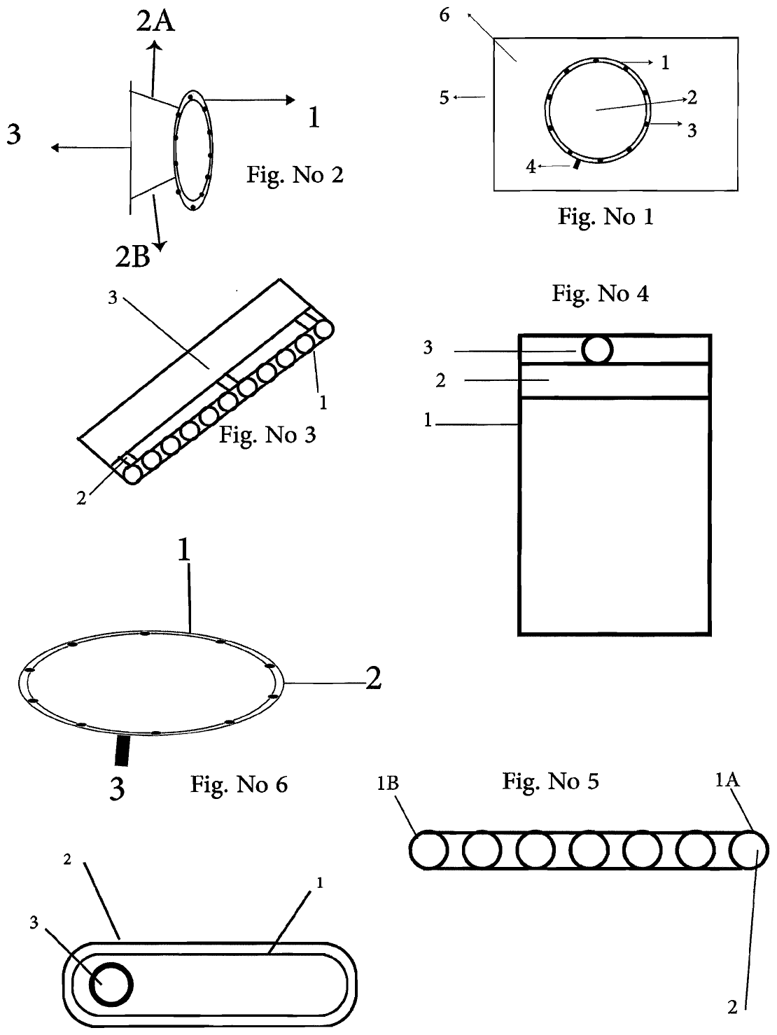

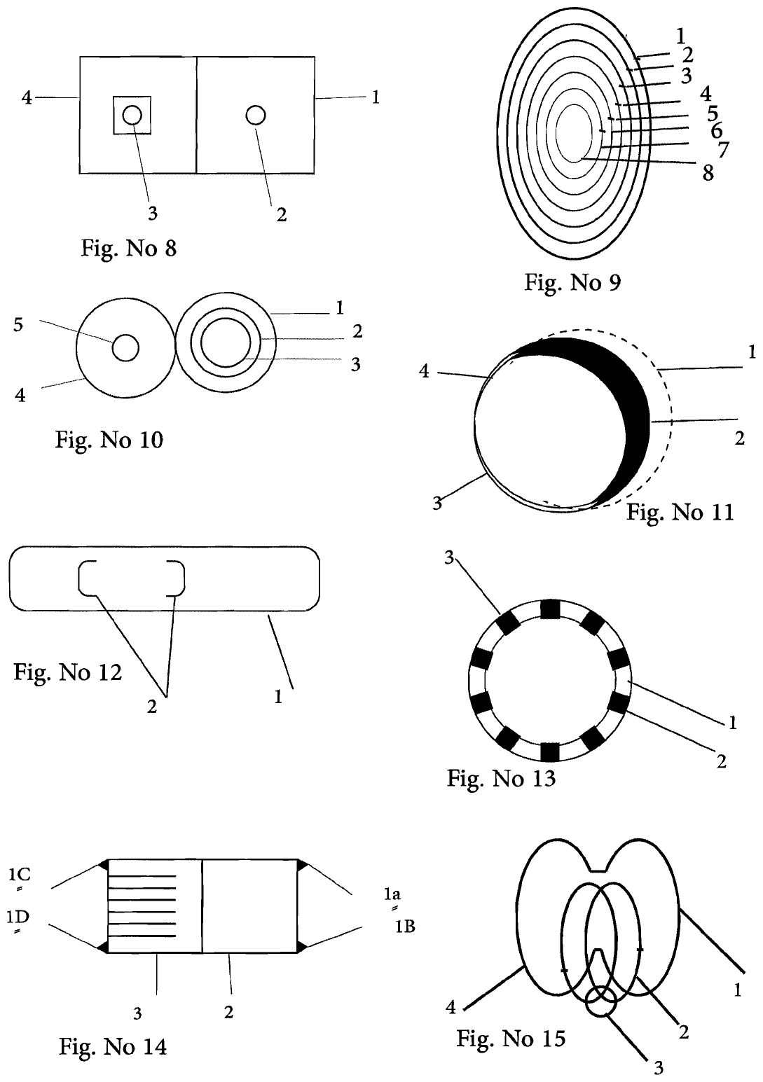

FIG. 4
1—Mobile body
2—A rubber for mounting fixed and moveable positive and negative lenses
3—Mobile camera

FIG. 6
1—A rubber body
2—A front opening for front mobile camera with positions for fixing one or more lens
3—A back opening for mobile camera with positions for fixing one or more lens
1—A rubber surrounding the mobile
2—A track for lens movement
3—A roof above the camera for bearing movable lens

FIG. 8
1—Lens holder
2—One or more lens
3—A track

FIG. 9
1—The method of operating lenses fixed on the lens holder
2—There are different methods for operating lens: fixing the lenses above the mobile lens, sticking a specific plastic piece to the lens and fixing it on mobile camera (referred to as an evacuated air method). Many lenses can be put on one another as desired; a holder is used for choosing the required negative or positive lens

FIG. 10
1—A lens collector
2—The place of the chosen lens
3—A mobile camera

FIG. 11
1—A hollow space for housing the chosen lenses that is accommodated in an opposite gap.
2—Fixing the lens through evacuated air
3—Changeable lens holder
4—A housing for the chosen lens, the lens holder can be fixed by a back holder provided with a spring for fastening the lens above mobile camera. It can also be fastened with a rubber piece.

FIG. 12
1—A rubber with suitable width and thickness surrounding the mobile for lens fixation in different ways
2—The lenses can be fixed without the use of the fixation band. In this case, they are fixed in a special housing through a specific lens protrusion; they are then fastened in housing above the rubber piece.
3—The lenses' numbers can be independently and previously chosen. They are fixed as mentioned in 2 or B.
4—The rubber piece should be adjusted on the mobile camera

The lenses are independently chosen with different numbers (+) (−)

FIG. 13
1—A rubber or plastic body
2—A front opening for front mobile camera
3—Single or multiple lens fixation points
4—A back opening for mobile camera with positions for fixing one or more lens

FIG. 14
a1 &B1—Fixation points above the rubber piece
C1&D1—Different right and left-moving lenses that allow for choosing the suitable positive or negative lenses

Different lenses that can be moved to the right and the left to allow for choosing suitable lenses with different positive or negative numbers, such as −1 to −10 or more and +1 to +10 or more.

A Note:

The camera lens can be used as a minimizing fixed lens (i.e. as a peephole or a mobile internal fixed lens)

FIG. 15

The figure is similar to the previous square one except for taking the shape of one or more right and left movable circuit, similar to the square or rectangular shape fixed on the rubber band.
1—Right and left movable lenses, fixed at the bottom, for picking the proper lens
2—A lens concentrator, whereas any desired lens can be used
3—Fixation method
4—A rubber with a specific position for lens fixation surrounding the mobile tightly
5-2 The required lens is fixed by evacuated air; it takes the shape of a plastic piece below the peephole
5-3 A rubber piece on which upward, downward, right and left movable lens is fixed. It is mounted on mobile camera for capturing photos either by the fixed lens or mobile camera.
5-4 The lens is fixed by a holder provided with a spring for locating the lens above mobile camera through a holder at the mobile back.
   A circular body containing lenses of different strengths (+1, +10 or more) fixed by an air aspirator on a specific rubber piece surrounding the mobile. The lenses rotate around an axis for converting the lenses to the right and the left for locating the suitable lens on mobile camera.
2—A lens-bearing band fixed on a rubber belt with a specific track for the band to move on in order to locate the proper lens on the mobile lens for capturing photos.
3—A body including the chosen lens fixed on a rubber piece

1- An integrated system comprising software and hardware.

2- The system according to claim 1, wherein the software comprises:
a—ordinary mirror
b—concave mirror
c—convex mirror
d—caricatural mirror
e—different advertising mirrors
f—changing the color of words, letters, numbers and back grounds.

3- The system according to claim 1, wherein the hardware comprises:
a—elastic or rubber band or the like, with suitable length and thickness, robustly surrounding the whole mobile, and having different colors and ornaments.

4- The system according to claim 3, comprising a rubber rectangle, a stand carrying one or more, fixed or moving lens.

5- The system according to claim 3, wherein the rubber rectangle has two parallel lines allowing the lens to safely move till standing above the mobile camera to take a selfie photo using a peephole-like lens, or a magnifying lens.

6- The system according to claim 4, wherein the rubber band has one fixed plus or minus lens mounted thereon to stand above the front or back phone camera.

7- The system according to claim 3, a rubber band with multiple lenses fixed thereon taking a square, rectangle or circular shape, that can move circularly to select the suitable lens to be placed above the mobile front or back camera; these lenses are plus or minus, magnifying or minimizing lenses.

8- The system according to claim 7, whereas two or more lenses located inside a square mounted on an elastic or rubber band, wherein such lenses moving inside a square or rectangle closed from 5 sides, and the desired lens may be selected to be placed above the mobile camera through a protrusion at the top or the bottom of the lenses.

9- The system according to the element (F) of claim 2 related to coloring letters,
1—letters, numbers and words may be colored in blue, yellow, orange, red and other colors, as desired, to allow reading at direct sunlight or under bright lights, and the backgrounds may also be changed into different colors to show words clearly.
2—The ability to clearly see words and numbers under bright lights by displaying them in different colors during chatting or messages.
3—Displaying the marks related to dialing or receiving a call in clear different colors. Besides, the keyboard may have different color to readily see it at sunlight, with the capability of changing its color.
4—While displaying letters or other marks at sunlight, the new technique tends to reducing the space, and compensating with a smaller diameter, while focusing on letters to appear shiner. That is, to concentrate light at the smallest possible space, using various colors.

10- The system according to claim 2 (A-B-C-D-E), whereas multi-purpose and multi-angled mirrors are used as follows.
1—Single or multiple mirrors in the same screen capable of vertical and horizontal rotation at different angles.
Mirrors of different shapes and colours can be mounted at multiple angles (magnifying mirror, minimizing mirror, close-up mirror and a peephole-like mirror)
2—A convex, concave, normal or a peephole-like mirror can be independently added. Otherwise, a number of grouped or independent mirrors may be used or one mirror that covers the whole screen.
3—An advertising mirror (either convex, concave, or normal mirror) can be used for presenting an advertisement on an external frame (vertical, horizontal or both). It may be used for fixed advertisements, a vertically or horizontally moving advertisement at the top and/or bottom of the screen or at certain points of the mirror.
4—Selfie photos can be taken using screen copying software or an external hardware key or the like. A peephole can be installed above the front or back camera to provide selfie photo either by photo capturing or screen coping.
5—The user's photo is reflected on the screen of the tablet, mobile or computer. Hence, selfie photo are available either by photo capturing or screen coping.
6—The mirror may match screen in size (computer, mobile or tablet screen). It displays the photos as a fixed or changing caricature in a rapid or slow motion. The screen is copied to have a caricature photo in accordance to the program design. A software program can be designed for converting single or multiple mirrors into moving caricatures of different shapes and positions or multiple conventional shapes. In other words, preshapes and drawing can be designed and manipulated by the program.
7—Mirrors can be fixed at the left, right and front to display the left, right and front sides of the face. The mirror can be designed at different shapes. Multiple mirrors can be fixed at any position of the screen to display caricature or normal faces photos that can be copied by screening copying software. Each mirror can rotate in any direction and at whatever angle. Each screen can be used for displaying fixed or moving advertisements.
8—Multi-coloured mirrors can be fixed in the one screen as desired. The mirror program does not prevent incoming calls and allows computer, mobile or tablet usage. Advertisement, as well as flowers or other pictures or expressions, can be fixed on or outside the mirror. The user can also write at any part of the mirror or screen

11- The system according to claim 1, whereas
1—The program is compatible with current operating systems (android, windows and IOS) as well as expected future operating systems
2—It operates on large screens. Selfie photos can be captured from such screens, whether mobile or computer screens.
3—Advertisements, according to the previous items, include both audio and video advertisements

12- The system according to claim 1, whereas
1—In ordinary mobiles, a normal or double mirror (a mirror with two faces: a magnifying and a minimizing one) is fixed under the back cover of the mobile. It rotates around a vertical axis for the user to see both front and back sides of the mirror.
2—Camera properties can be altered using a circuit with slides. In other words, the circuit is divided into multiple magnifying or minimizing slides and close-up or a peep-like slides fixed above camera lens for near and far photos. Hence, the camera lense can work as a peephole that displays near objects as distant for capturing selfie images.
3—An external lens, like a peephole, can be used. It is easily fixed and removed in case of selfie photo capturing. It can be fixed on the front or back camera in simple ways. The magnification range of the peephole can be determined. It can be designed with properties that satisfy users' needs.
4—Circuits with magnifying or minimizing slides are fixed to rotate clockwise or counterclockwise on an axis. Otherwise, the slide-bearing bar is mounted to rotate reciprocally or as a cassette

13- The system according to claims 1 and 3, whereas
1—A fixed circular, rectangular or square rubber piece integrated in the peephole fixed on the mobile camera. It is used for selfie photo capturing or magnifying photos.
2—A rubber piece with openings and special location for peephole. Lenses above the rubber piece can be changed as desired.
3—A rubber band with a protrusion for peephole fixation.
4—A rubber band surrounding the mobile for fixing lenses of different capabilities.
5—The lens rubber is fixed between the lens and the mobile back by a special holder for locating the lens on mobile camera.
6—The lenses are designed to operate in mobiles in a circular way, rotatable lenses of different capabilities distributed around a circuit (A).
The circuit moves to the right and the left for locating the proper lens above mobile camera through a zigzag circuit periphery protruding out of the mobile.
In addition, there are mobile-integrated lenses that works reciprocately or as a cassette according to the same idea mentioned in A, 6a and 6b. It is operated electronically, mechanically or manually as desired.
7—The lens is fixed on mobile camera through a spring or an aspirator.
8—The lens-bearing band is fixed on a rubber piece. In case of choosing one lens, it freely moves on the rubber for locating the lens on the camera.
9—The circular lens is fixed by a special holder or by a rubber around the mobile. It is fixed on a special housing above the rubber.
10—Other objects can be intergrated into the rubber band surrounding the mobile. They are configured to fix the circular, square, rectangular or other lenses.
11—A rectangular or circular band that is automatically, electronically or manually operates inside and outside the mobile, on which magnifying or minimizing slides are fixed.
12—Shapes of different designs performing the same function, as illustrated in the drawings description.
13—Advertisements, mentioned above, refer to legible, audio and video advertisements.
